(19) United States
(12) Patent Application Publication
(10) Pub. No.: US 2006/0015636 A1
(43) Pub. Date: Jan. 19, 2006

(54) Method for selecting among network interfaces, device with multiple network interfaces and application

(75) Inventors: Ryan Skraba, Paris (FR); Gregory Watts, Palaiseau (FR); Frederic Weis, Saint Malo (FR); Michel Banatre, La Fresnaie (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/152,244

(22) Filed: Jun. 15, 2005

(30) Foreign Application Priority Data
Jul. 1, 2004 (EP) 04 291 679.1

(51) Int. Cl. G06F 15/16

(52) U.S. Cl. 709/232

(57) ABSTRACT

For enabling an application for a device with multiple network interfaces to select among network interfaces to transmit its data, an interface between the application and the network layer of a protocol stack is provided for providing information on network interface availability to the application (5), selecting the network interface by the application (61) and submitting the selected network interface as parameter to the network layer (62).

### BACKGROUND OF THE INVENTION

The invention is based on a priority application EP 04 291 679.1 which is hereby incorporated by reference.

The present invention relates to the field of telecommunications and more particularly to a method for enabling an application for a device with multiple network interfaces to select among network interfaces to transmit its data, a device with multiple interfaces and an application for it.

As the availability of different standards of wireless and wired networks increases and new devices that can profit from multiple networks (so-called “multi-homed” devices) enter the market, it will become increasingly popular for providers to offer their services over these heterogeneous networks. This is primarily relevant for mobile devices, where the network availability frequently changes, such as laptop computers, tablet computers, personal digital assistants (PDA) and GSM (global system for mobile communication) mobile phones with alternative network interfaces, e.g. WLAN (wireless local area network) or Bluetooth in addition to GPRS (general packet radio service).

Many of these devices offer a network layer, where one interface can be activated or deactivated programmatically. Activating and deactivating a network interface programmatically affects all applications on a device and does not provide a fine-grained per-application network selection. One application, for example, should be able to send a small amount of data over a highly reliable, costly network while another application should be able to choose a less expensive, transient network for large transfers.

Another possibility is to use IP(internet protocol)-connected devices offering IP routing tables that can be programmatically modified so that packets can be sent to a specific network interface according to the desired destination. But it is impossible to create a routing table that allows using different networks for the same destination.

If one uses an IP-connected device that provides a socket API (application protocol interface), a particular network interface can be selected by specifying the IP address of the network interface. But IP-connected devices using the socket API have to track changes to their IP addresses as the underlying networks change, and to match them to their network interfaces. In addition, there is a requirement that the IP address exists for the network interface before the application can interact with it.

Mobile phones frequently have a separate API for each available network interface, such as under the Symbian operating system, which uses different system calls for GPRS data transfer and Bluetooth data transfer. While providing different APIs for different network interfaces allows for fine-grained per-application control of interfaces, it involves rewriting the networking component of the application for each interface/API.

### SUMMARY OF THE INVENTION

It is an object of the present invention to allow for fine-grained per-application network interface selection when using devices with multiple network interfaces. This object, in addition to others, is achieved by means of a method according to claim 1, a device according to claim 7 and an application according to claim 9. Further advantageous features of this invention are indicated in the dependent claims. All the claims are understood to be integral parts of the description.

By providing an interface according to the invention, it is possible for the network layer to make different network interfaces available to an application. The network layer is one of several layers of a protocol stack. It provides the functional and procedural means of transferring variable length data sequences from a source to a destination via one or more networks. In particular, the network layer addresses messages and translates logical addresses and names into physical addresses. Other layers of a protocol stack are e.g. the physical layer defining the electrical and physical specifications for devices, or the application layer performing common application services for the application. Protocol stacks are described in more detail for example in the Open Interconnection System (OSI) Reference Model.

One of the main advantages of the new interface is that it is independent of the specific network interface to be used for transmitting data. The interface according to the invention allows for a lot of flexibility in selecting the network interface. The application gets information on network interface availability and can consider further parameters such as data size, priority, cost, transmission speed etc. to select a specific network interface. Via the interface, the application then submits the selected network as parameter to the network layer. With this information, the network layer can establish a connection using the selected network interface.

### BRIEF DESCRIPTION OF THE DRAWINGS

A detailed description of the invention is provided below. Said description is provided by way of a non-limiting example to be read with reference to the attached drawings in which:

FIG. 1 schematically shows the concept of data transmission;

FIG. 2 schematically shows the application and the network layer;

FIG. 3 schematically shows a first embodiment of the method according to the invention;

FIG. 4 schematically shows a second embodiment of the method according to the invention;

FIG. 5 schematically shows a third embodiment of the method according to the invention.

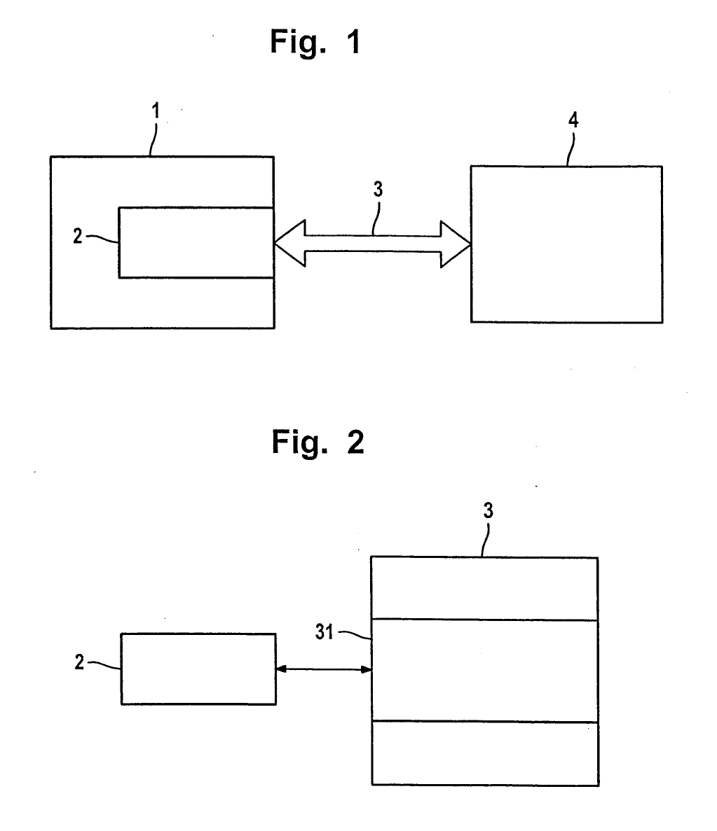

FIG. 1 shows schematically a mobile device 1 with an application 2 running on it. To transmit data from the device 1 to a location 4 or vice versa, a protocol 3 is needed to establish a connection over a network, process the data and actually transmit the data. The protocol 3 is implemented partly or totally in the application 2 and/or the device 1 and/or the location 4.

The device 1 could be for example a mobile phone, a laptop, a PDA or a tablet computer. Possible applications 2 could be e.g. sending/receiving SMS (short message service), MMS (multimedia message service), emails, music, synchronizing data etc. Some generally known protocols are for example http, ftp, telnet, TCP/IP and Ethernet.

In general, one speaks of a protocol stack 3, because an interconnected application can abstractly be described as having a layer design (see FIG. 2). In the OSI Reference Model for example, each layer has the property that it only uses the functions of the layer below, and only exports functionality to the layer above. Protocol stacks can be implemented either in hardware or software, or a mixture of both. Typically, only the lower layers are implemented in hardware, the higher layers are implemented in software. One of the stack layers is the network layer 31.

The application 2 has to communicate with the network layer 31 of the protocol 3 to get the necessary information on network interface availability for selecting the network interface to be used for data transmission, and to inform the network layer 31 of the selected network interface in order to get the correct connection established. According to the invention, an appropriate interface (symbolized by the arrow in FIG. 2) between application 2 and network layer 31 is provided that allows for submission of the selected network interface from the application 2 to the network layer 31.

In preferred embodiments of the invention, this interface is a Java interface based on usual standards. The virtual machine on the application level and on the network layer level is modified in order to allow the application to submit the selected network interface as parameter and to allow the network layer to accept the selected network interface as parameter. By doing so, the implementation is transparent, i.e. all other functions of the application with the interface according to the invention will run normally with all network layers, other applications will run normally with network layers having this interface, and the application according to the invention with an unadapted network layer, e.g. the interface being only partly implemented on the application side, will generate a defined error message.

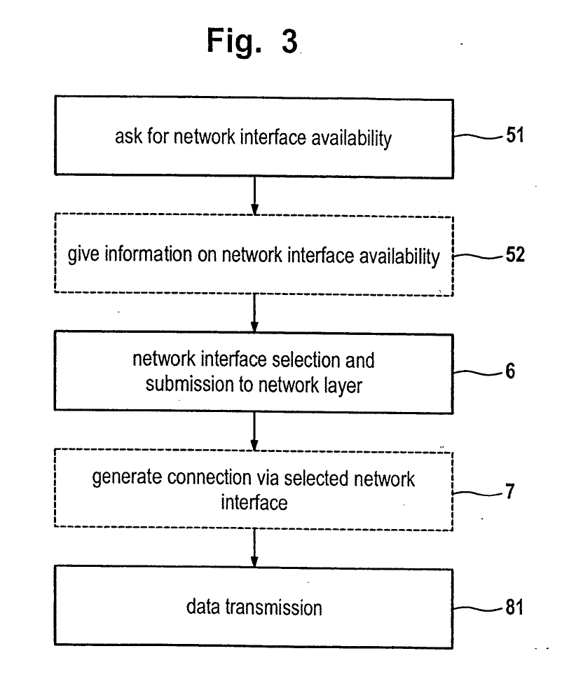

In FIG. 3, an example for an embodiment of the method according to the invention is explained more in detail. The actions mainly occurring on the application side are symbolized by a box with a plain line, and the actions occurring mainly on the network layer side are symbolized by a box with a dotted line.

To be able to select a network interface, the application first needs to know, what network interfaces are available. This depends not only of the hardware components of the device on which the application is running, but also on what networks are available. If one considers usual mobile devices, possible networks could be e.g. WLAN, Bluetooth, GSM. One possibility to acquire this necessary information is illustrated in FIG. 3. The application can query system properties to find information about the availability of network interfaces (action 51). If one uses a Java interface, it is preferable to use the MIDP 2.0 standard and to query MIDP properties. The network layer answers the query of the application by giving the queried information (action 52).

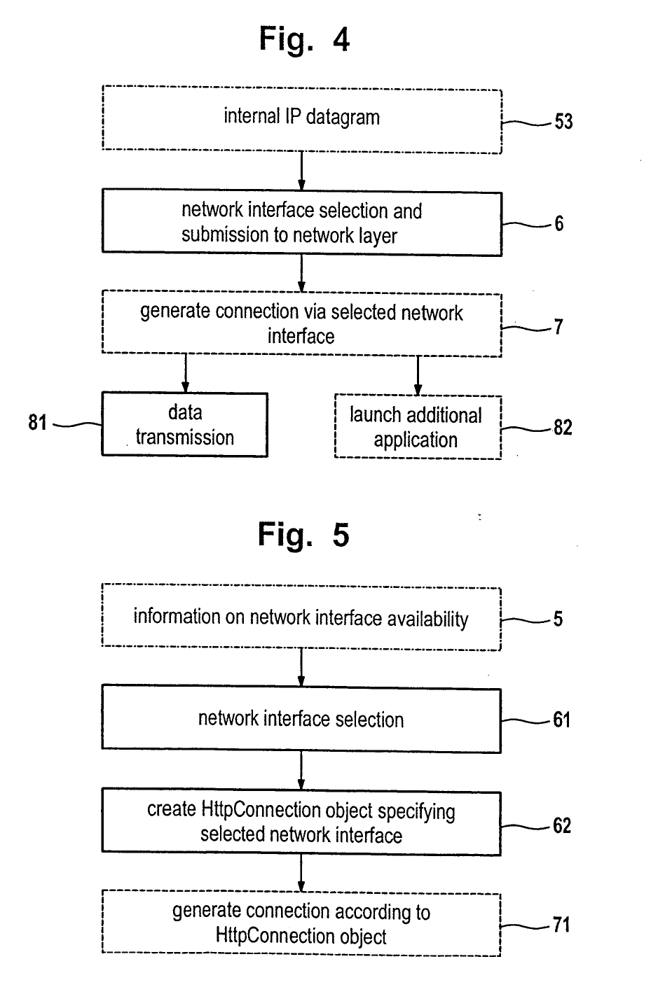

Another possibility is illustrated in FIG. 4. There, the application is notified via IP datagrams on an internal socket (action 53). Because this action is not localized at the application or the network layer, the symbolizing box shows a dash-dotted line. This possibility is advantageous for mobile devices, which frequently deal with changing network availability. By using datagrams, the application may be constantly notified of network changes.

Once the application has been provided with the necessary information on network interface availability, it can proceed with the network interface selection (action 6). Further important selection criteria may be data size, priority, transmission speed, cost etc. Every application can have its own particular selection criteria and choose different network interfaces for transmitting different data to or from the same location. This ensures that the available network interfaces are always used optimally.

After intelligently choosing the preferred network interface from the available network interfaces, the network layer is notified of the selected network interface (action 6) and generates a connection via this selected interface (action 7) to enable data transmission to or from the application (action 81).

In preferred embodiments, as schematically illustrated in FIG. 4, the network layer not only generates a connection via the selected interface (action 7), but also launches an additional application (action 82). Different levels of availability of network interfaces can thus be made accessible to applications. For example, an authentication client could be interested when WLAN media is available, and could launch the authentication of the device to obtain IP connectivity. Subsequent applications would be interested in the network interface when IP connectivity is available. Additional applications may be launched by the first application, too. Applications that are strongly related to the process of connection like authentication clients are preferably launched automatically by the network layer.

FIG. 5 shows more in detail an embodiment of the method according to the invention using a Java interface according to the MIDP 2.0 standard between the application and the network layer. The Java MIDP 2.0 environment has the advantage of being highly portable. An implementation of the method according to the invention in this environment makes it applicable to a wide range of devices. In this environment, connections to network services are typically made through a well-defined Java interface called HttpConnection, which takes a URL (universal resource locator) as a parameter. Normally for an URL such as “http://path/to/resource”, the protocol (in this case http) is independent of the underlying network interface. Data is sent to the TCP/IP stack, which uses an IP routing table to choose the appropriate network interface.

After having gotten the network availability information either by query and answer or internal datagram (action 5), and after selection of the network interface to be used (action 61), the application generates an object “httpGPRS://path/to/resource” (action 62). Thus, the implementation of the method according to the invention adds functionality to the Java virtual machine such that the protocol of the specified URL may explicitly choose the network interface (in this case GPRS). That is, a HttpConnection using the URL “httpGPRS://path/to/resouce” will always make the network connection over the GPRS interface. Likewise, the same application may specify the URL “httpWiFi://path/to/resource”, which would always make the connection over the WLAN interface. After an HttpConnection object is created, the underlying application is completely transparent to the application.

The network layer generates a connection according to the HttpConnection object (action 71). It is responsible for assuring that the correct network interface is used for the protocol specified by the application. It is important to note that the Java standard, like MIDP 2.0 is extended without breaking it. Thus, existing applications that are compatible with the Java Standard can be easily modified to include the features of the present invention.

The method according to the invention offers fine-grained, per-application control over the selection of the network interface, but retains the transparency of the network interface after it has been selected. Accordingly, applications can be written and devices can be constructed to take advantage of this exchange of information on network interface availability and selected network interface implementing the method as software and/or hardware and, thus, provide a flexible and responsive service to the user, especially of mobile devices.

The invention shall be illustrated more vividly in a further example concerning MMS delivery. A portable computer was equipped with multiple network interfaces, i.e. WiFi using a WLAN card and GPRS using a connected mobile phone and/or a wired LAN. An application was written to take advantage of the multiple network interfaces. Specifically, the user was offered the capability to compose an MMS and send it immediately over GPRS, or to wait until the terminal entered a WLAN hotspot. Likewise, on receiving a MMS notification, the user could either immediately download it and, in this case, prefer WLAN connectivity if it exists over the more expensive and slower GPRS, or wait until the terminal entered a WLAN hotspot. This offers the user more options and responsiveness from their terminal, which should translate to increased usage of the service and increased revenue for the service provider.

Although having described several preferred embodiments of the invention, those skilled in the art would appreciate that various changes, alterations, and substitutions can be made without departing from the spirit and concepts of the present invention.

1. A method for enabling an application for a device with multiple network interfaces to select among network interfaces to transmit its data, by providing an interface between the application and the network layer of a protocol stack for
providing information on network interface availability to the application;
selecting the network interface by the application;
submitting the selected network interface as parameter to the network layer.

2. The method of claim 1 wherein the interface between the application and the network layer is a Java interface.

3. The method of claim 1 wherein an object containing information on the protocol and the network interface is generated by the application for submitting the selected network interface as parameter to the network layer.

4. The method of claim 1 wherein the information on network interface availability is provided by internal datagrams.

5. The method of claim 1 wherein the information on network interface availability is provided by the application layer querying information from the network layer.

6. The method of claim 1 further comprising the step of calling an additional application on the network layer level.

7. A device with multiple network interfaces wherein it comprises means for the implementation of the method of any one of claims 1 to 6 claim 1.

8. The device of claim 7 wherein the device is mobile.

9. An application program for a device with multiple network interfaces wherein it implements the method of claim 1.
